(19) United States
(12) Patent Application Publication
(10) Pub. No.: US 2012/0019214 A1
(43) Pub. Date: Jan. 26, 2012

(54) Self-Powered Functional Device Using On-Chip Power Generation

(76) Inventor: Muhammad M. Hussain, Austin, TX (US)

(21) Appl. No.: 13/185,786

(22) Filed: Jul. 19, 2011

Related U.S. Application Data
(60) Provisional application No. 61/367,276, filed on Jul. 23, 2010.

(51) Int. Cl. H02J 7/00; H02J 4/00

(52) U.S. Cl. 320/138; 307/43

(57) ABSTRACT

An apparatus, system, and method for a self-powered device using on-chip power generation. In some embodiments, the apparatus includes a substrate, a power generation module on the substrate, and a power storage module on the substrate. The power generation module may include a thermoelectric generator made of bismuth telluride.

### CROSS-REFERENCE TO RELATED APPLICATIONS

This application claims priority to U.S. Provisional Application No. 61/367,276 filed Jul. 23, 2010, the entire contents of which is specifically incorporated herein by reference.

### BACKGROUND OF THE INVENTION

1. Field of the Invention

This invention relates to on-chip power generation and more particularly relates to a self-powered device.

2. Description of the Related Art

Handheld devices typically have a battery that must be charged periodically. Efforts to increase the time between charges has included attempting to increase the power storage capacity of batteries and to lower the power consumption of the circuitry on the devices.

### SUMMARY OF THE INVENTION

An important factor for a self-powered device is to lower power consumption and at the same time generate power on-chip to supply the required power.

A self-powered device using thermoelectric generation is presented. In one embodiment, the apparatus includes a substrate, one or more power generation modules on the substrate, and one or more power storage modules on the substrate. In addition, some embodiments include one or more control modules on the substrate, where the one or more control modules are configured to control the flow of energy between the one or more power generation modules, and the one or more power storage module. Some embodiments also include one or more communication modules on the substrate, where the one or more communication modules are configured to send and receive information to the one or more control modules.

In some embodiments, the self-powered device includes a sensor coupled to the one or more control modules, where the one or more control modules are responsive to an output of the sensor. The sensor may be but is not limited to a temperature sensor.

In some embodiments, the one or more power generation modules may include a solar cell, and the solar cell may include nanowires. In some embodiments, the one or more power generation modules may include a piezoelectric energy harvester. The one or more power generation modules may also include a thermoelectric energy harvester. In some embodiments the one or more power generation modules may include a fuel cell, and the fuel cell may be a microbial fuel cell. The microbial fuel cell may comprise a nanostructure such as carbon nanotube having vertical walls, rounded walls, a slope greater than 50°, and/or a slope greater than 70°. In some embodiments, the microbial fuel cell has a surface to volume ration greater than 500 cm⁻¹.

In some embodiments, the one or more power storage modules comprises a battery. The battery may be a lithium ion battery. Additionally, the one or more control modules may include a nano-electromechanical switch.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a schematic block diagram illustrating one embodiment of a self-powered device using thermoelectric generation.

FIG. 2 is a schematic block diagram illustrating one embodiment of a microbial fuel cell.

FIG. 3 is a chart showing the surface-to-volume ratio for anode carbon nanotubes used in microbial fuel cells.

FIG. 4 is a schematic block diagram illustrating one embodiment of a thermoelectric generator used in a self-powered device.

FIG. 5 is a chart showing the relationship between output power and temperature difference in one embodiment of a thermoelectric generator.

FIG. 6 is a chart showing power dissipation in transistors of different geometry sizes.

### DETAILED DESCRIPTION

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

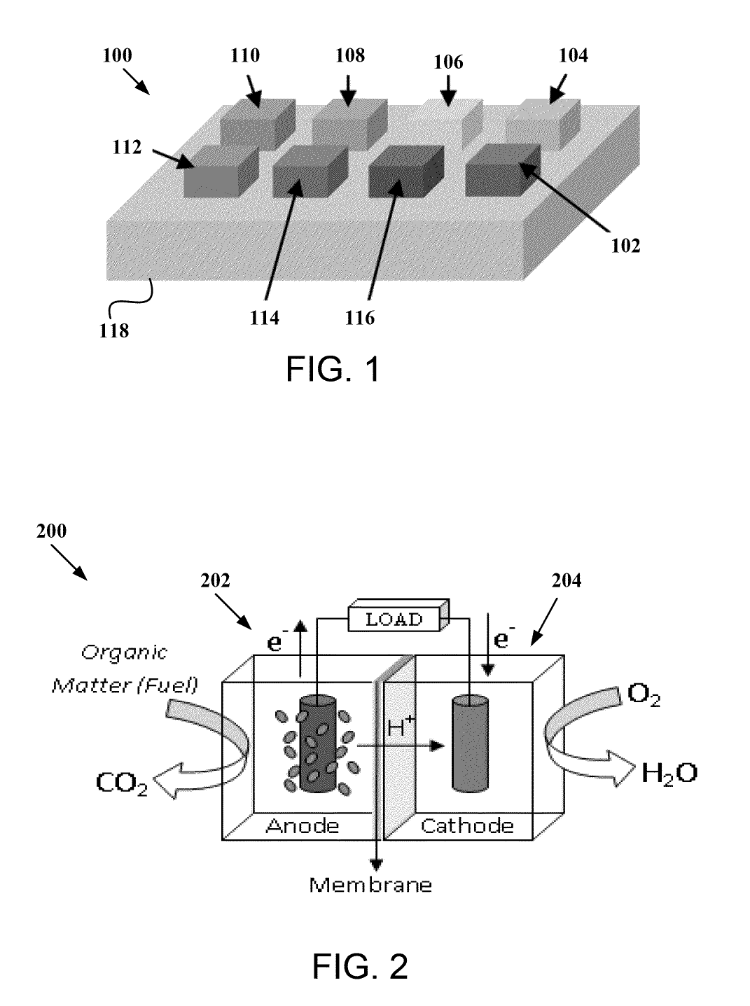

FIG. 1 shows one embodiment of a self-powered device 100. It includes two main power parts: power consumption and power generation, which are both formed on a substrate 118. In some embodiments the substrate 118 may be a silicon wafer, on which the rest of the components may be formed. Alternatively, the substrate may be a printed circuit board, or series of boards, that may serve to physically support the components and provide electrical connections between the components.

The power generation section includes a power storage module 108, a fuel cell 114, a thermoelectric generator 106, a solar cell 110, and a kinetic energy harvester 112. The battery 108 may be a rechargeable Lithium-Ion battery (LIB). The fuel cell 114 may be a hydrogen fuel cell, and in some embodiments may be a microbial fuel cell (uMFC). The thermoelectric generator (TEG) may use bismuth telluride. The solar cell may use nanotubes, and the kinetic energy harvester may be a piezoelectric energy harvester (PNG).

The power consumption section comprises a control module 102, a communication module 104, and may include sensors 116. Collectively, these components are responsible for controlling the supply of power to the load application. The control module 102 may contain circuitry that monitors and controls the flow of energy between the power generation module(s), the power storage module(s), and the energy consumption module(s). For example, when additional power is required, the power control module 102 may increase the generation in the fuel cell 114. Alternatively, if the solar cell 110 is providing sufficient energy for the system, the control module 102 may reduce the output of the fuel cell 114.

The communication module 104 may be configured to communicate with other components in the system to relay information regarding power consumption and generation. Additionally, the communication module 104 may be configured to communicate with remote systems. In some embodiments, this communication may be accomplished using a communications protocol such as Ethernet. The communication module 104 may also have additional processing capabilities that may include a microprocessor configured to process information received in the communication module 104.

In some embodiments, the self-powered device 100 may include one or more sensors 116. A sensor 116 may be a temperature sensor, such as a thermocouple. A temperature sensor, for example, can serve to monitor the functioning of the fuel cell 114. A temperature sensor may also be used to monitor the temperature of a lithium ion battery. The temperature of a lithium ion battery may be useful to control the charge of the battery as well as detect a failure in the battery.

The fuel cell 114 may be a microbial fuel cell that comprises a carbon nanotube having vertical walls. The microbial fuel cell may also have carbon nanotubes having rounded walls. The carbon nanotubes may have a slope greater than 50°. In some cases, the carbon nanotubes may have a slope greater than 70°.

FIG. 2 shows one embodiment of a microbial fuel cell 200. The microbial fuel cell 200 has an anode 202 and a cathode 204. The anode 202 comprises an electrode that produces hydrogen by consuming organic matter. Microbes in the anode 202 may consume organic matter and expel hydrogen gas and (carbon dioxide) CO₂ gas. The hydrogen gas may then be passed through a membrane to the cathode 204. The membrane may be specifically designed to only allow hydrogen to pass over to the cathode 204. Once in the cathode 204 region, the hydrogen may combine with oxygen to create electrical power and water. One advantage of this microbial fuel cell 200 is that it consumes organic material and expels only CO₂ and water, which makes it an environmentally responsible energy source.

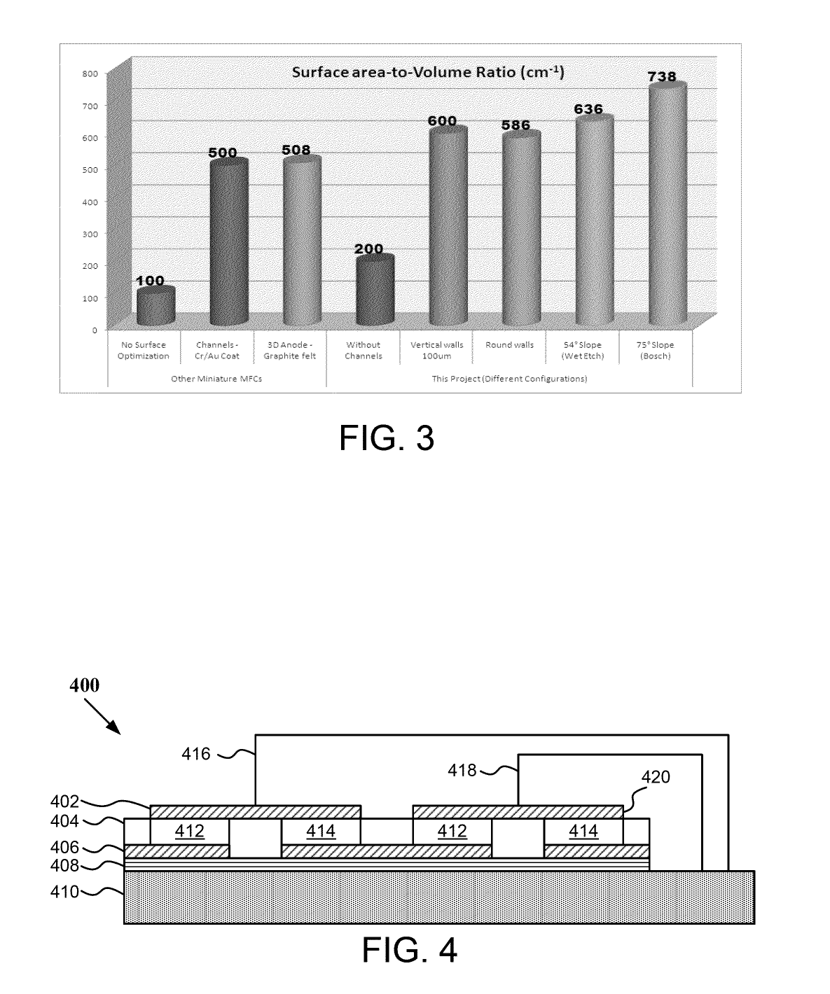

FIG. 3 is a chart that shows the surface-to-volume ratio (SVR) for different configurations of anodes in a microbial fuel cell. These anodes are made of carbon nanotubes (CNTs) and have different geometries that affect their surface-to-volume ratio. In some embodiments, a larger surface-to-volume ratio is preferable to a smaller ratio. As seen in FIG. 3, a CNT without surface optimization has a SVR of 100 cm⁻¹. A CNT with channels having chromium (Cr) and gold (Au) has a significant increase in SVR, to 500 cm⁻¹. A 3D anode has a SVR of about 508 cm⁻¹. A configuration without channels as used in some embodiments has a SVR of about 200 cm⁻¹. However, using a configuration of CNTs having vertical walls may increase the SVR to 600 cm⁻¹. Round wall have almost the same SVR, which is 586 cm⁻¹. Increased SVRs are possible using CNTs having different slopes. For example, a 54° slope can achieve a SVR of 636 cm⁻¹. A 75° slope can achieve a SVR of 738 cm⁻¹.

FIG. 4 shows one embodiment of a thermoelectric generator 400 on a self powered device 100. The thermoelectric generator is formed on a substrate 410, which may be the same substrate 118 in FIG. 1. Alternatively, substrate 410 may be a chip or other component in one of the other components. For example, the substrate 410 may be a portion of the fuel cell 114 that transmits heat. On the substrate 410 is an optional layer of heat conducting material 408. In some cases the heat conducting material may help to thermally couple the heat source and the thermoelectric generator 400.

A first conductor 406 is in a first plane. The first conductor 406 is coupled to a first thermoelectric region 412 and a second thermoelectric region 414. In some embodiments, the first thermoelectric region 412 may be n-type bismuth telluride and the second thermoelectric region 414 may be p-type bismuth telluride. The first thermoelectric regions 412 and the second thermoelectric regions 416 are in a second plane. In this embodiment, the second plane is adjacent, parallel, and directly above the first plane. The second conductor 420 and the third conductor 402 are in a third plane. In this figure, the third plane is adjacent, parallel, and directly above the second plane. The second conductor 420 is coupled to a first thermoelectric region 412 and a second thermoelectric region 414. The third conductor 402 is similar to the first conductor 402, but is connected to different first and second thermoelectric regions 412 and 414. Electrical leads 416 and 418 are connected to the second conductor 420 and the third conductor 402 and may be connected to the substrate 410. The electrical connection to the substrate may allow the thermal energy created in the substrate 410 to be captured and sent back to the substrate in electrical form. In some embodiments, the thermoelectric generator 400 may be connected to an integrated circuit such as a microprocessor.

### EXAMPLES

The following examples illustrate specific embodiments of particular components that may be used in a self-powered device 100. These examples are provided by way of illustration, not limitation.

A. SOI & HK/MG Technology

Because bulk CMOS technology is matured and well-established, it is important to use it as a base platform for device integration. Recent advances in process technology such as lithography, use of high-k/metal gate stack have helped in producing smaller, low-power devices. As one purpose of the self-powered chip is to consume minimal power, chip components such as the control circuit, communicator etc should use such small and low power devices. One method of reducing power is to use a low cost ETSOI (Extreme Thin SOI) CMOS process. Although SOI technology may be expensive, the ETSOI technology may offset this by using a reduced number of masks, implantation steps, and process complexity. Featuring an un-doped channel and dual in-situ doped epitaxial S/D and extension regions, the ETSOI CMOS device achieves very low V_{T} variability and low V_{DD} at a gate length of 25 nm and an I_{off} of 300 pA/μm.

B. CNT (Carbon Nanotube) Technology

Carbon Nanotube (CNT) technology is very quickly leaning towards the next generation of electronics in replacing standard MOS technology. CNT field effect transistors (CNTFETs) in particular have taken the spotlight recently because of their ballistic charge transport property and low power consumption. CNTFETs with specifications that outperform current Si technology have been fabricated in the past, with the popular gate all around (GAA) fabrication process. But this process technology suffers from a minimum dielectric thickness criteria of 8 nm. One possible improvement is to use the LBG (local back gate) geometry developed by Franklin et al. reporting a 1.2 nm diameter p-type CNTFET and an L_{g} of 38 nm exhibiting ballistic charge transport properties and an Iₒₙ/I_{off}>10⁵. The benefits of using CNTFETs are numerous compared to standard Si technology such as low power operation. Besides this, a single CNT can be used to fabricate multiple gate transistors while at the same time allowing aggressive scaling. P-type CNTFETs comprise Pd-contacts because of the low Schottky Barrier (SB) between the metal and the semiconducting CNT interface. For the n-type FETs, the local back gate is grounded and the channel region is covered by a normal high-k & metal gate stack. The source and drain regions are then doped with K (Potassium) which then make it an nFET.

C. Nanowire Technology

Nanowire (NW) based device technology is also an emerging field and is popular because of the ability to produce high density logic devices while occupying lower chip real estate and consuming low power. One drawback of NW technology is their integration into circuits. Although there are several NW assembly techniques such as NW-TFTs, crossed NWs, direct NW growth etcetera, most of the integration processes involved are either not compatible and/or do not have the required performance figures. However, it is possible to fabricate a back-gated ZnO NW nFET exhibiting an off-state drain current less than 1 pA, Iₒₙ/I_{off}=10⁷ and an electron mobility of 50 cm²/Vs. The ZnO NWs are grown using wet chemical synthesis at 150° C. in an aqueous solution of sodium hydroxide and ammonium peroxodisulfate using a zinc foil as the growth substrate. Annealing at 600° C. is performed to remove dopants from within the ZnO nanowires. The synthesized NWs are then transferred to a heavily doped thermally oxidized silicon substrate. Al contacts are used for the source and drain. The heavily doped silicon substrate acts as the gate electrode.

D. NEMS: Nano Electro Mechanical Switches

CNT and graphene based NEMS exhibit excellent mechanical properties and high electron mobility. CNT-NEMS can operate in the GHz range at CMOS comparable gate voltages. Graphene-NEMS have been explored, where vibrational frequencies in the MHz range were achieved. Hybrid CMOS-NEMS circuits have been fabricated to combine memory and logic circuits together. Using CMOS integrating techniques, it successfully fabricated such a hybrid device using a fin flip-flop actuated channel transistor, that exhibit very high data retention type.

### Power Generation

A. Microbial Fuel Cell (uMFC)

A Microbial fuel cell (FIG. 2) is an innovative device for energy production based on bio-electrochemical reactions made by bacteria when decomposing organic matter in anaerobic conditions. Typically it comprises anode and cathode compartments separated by a membrane (Proton Exchange Membrane). In the anode compartment, fuel is oxidized by microorganisms, generating electrons and protons. Electrons are transferred to the cathode compartment through an external electric circuit (load), and the protons are transferred to the cathode compartment through the membrane. Electrons and protons are consumed in the cathode compartment, combining with oxygen to form water.

So far, researchers have focused their efforts to create macro-scale MFC for massive production of energy. In another approach, a micro version MFC acts as an alternative power source for self-powered Microsystems. In the self-powered device, the Microbial Fuel Cell uses microfabrication techniques and novel nanomaterials, thus greatly improving the output energy density. The central breakthrough of this design encompasses the microfabrication of the smallest MFC reported thus far, and the use of a 3D structure CNT-based anode, with a high surface area-to-volume ratio (FIG. 3).

B. Lithium Ion Battery (LIB)

An attractive option for power storage is the Lithium Ion Battery (LIB). Its power density per unit volume or per unit mass is higher than other techonologies. Consequently the LIB is a key component in the power generation module of the device. Nowadays, increasing the energy density, cycling life and charge/discharge rate capability is a main concern for the improvement of the LIB. In order to achieve this, two different alternatives are proposed; the use of hollow Nanostructures or the use of Nanowires. In the first case, the lithium storage capacity is increased thanks to the extra space for the storage of lithium ions inside the cavities in the hollow structures. For the second case, a particular composition for the Nanowires can be used, in which it is combined the efficient electron conductivity of the carbon and the very high lithium storage capacity of the silicon (4200 mA.h.g⁻¹). Using either of these schemes it is possible to increase the storage capacity and cycling life of the battery.

C. Thermoelectric Power Generator (TEG)

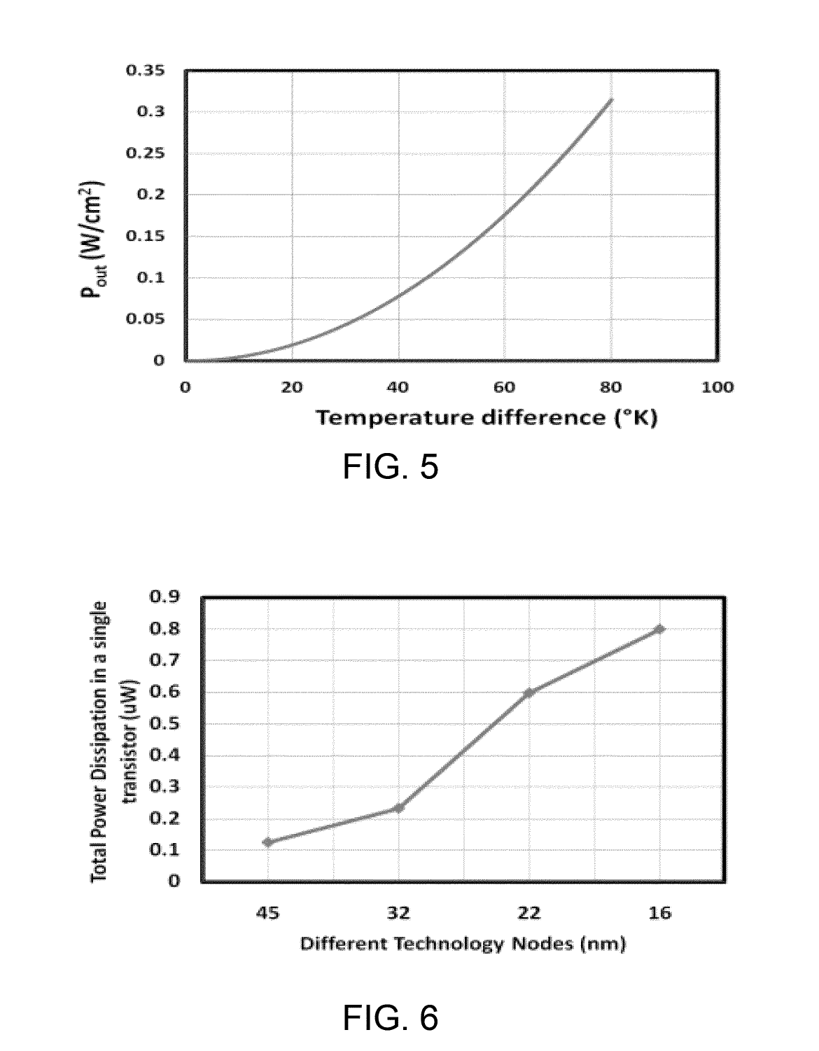

Aggressive scaling of transistor sizes from the micrometer to the nanometer range has caused a significant increase in power (gate-leakage) dissipation (FIG. 6). Removal of this heat is continually becoming a problem with conventional heat removal techniques, especially in portable mobile devices. To tackle this, transistors with different dielectric material and metal gate topologies have been proposed and developed. Nonetheless there will always be some amount of heat dissipation in CMOS circuits. A self-powered device may have a TEG that converts heat dissipated from the load application and the power consumption section into reusable energy that charges the LIB. Based on a comparative study on the conversion efficiency and figure of merit (ZT) for different thermoelectric materials: Bi₂Te₃ and (Bi,Sb)₂Te₃ are choice of materials for the TEG (FIG. 5).

D. Piezoelectric Power Harvester

Because the self-powered device is sometimes targeted towards mobile/remote harsh environment applications, it will be subjected to lots of movement, strain and vibrations. The self-powered device may include a piezoelectric device that converts mechanical signals (kinetic energy) to electric power. A recent development in piezoelectric nanogenerators showed the possibility of using ordered ZnO NWs (grown by VLS) and a zig-zag patterned Pt metal probe contact to convert the aforementioned mechanical signals into DC current. From a single 300 nm diameter & 0.2 um-0.5 um long ZnO, 45 mV output voltage was obtained. The reported power density per unit substrate area was 0.1-0.2 mWcm⁻².

E. Nanowire Based Solar Cell

In addition to the above energy harvesters, a solar cell can be integrated into the self-powered device. A recent publication described a solar cell (SNOP) based on n-CdS nanowires grown on an anodized aluminum membrane and a p-CdTe thin film. Using an ordered single crystal CdS nanowire array coupled with the CdTe photo absorption layer, an efficiency of 6% was demonstrated from a 5×8 mm chip.

### Analytical Calculations

Based on the data from previous miniature MFCs, and given the dimensions and improvements involved in the present design, the power density is of the order of 10 W/m³. So, considering the volume of the MFC to be 1.25 μL, 12.5 nW of power is achievable. The proposed TEG comprising 450 (n-Bi₂Te₃ & p-(Bi,Sb)₂Te₃) couples having an area of 20 μm×35 μm, for a temperature difference of 30° C., the estimated Pₒᵤₜ is 0.35 μW (FIG. 5). The thin film batteries that use a thick LiCoO₂ layer as cathode (>4 μm), energy densities of 2-3 mWh/cm², having integrated a battery of 1 cm×1 cm area, working for an hour can provide a Pₒᵤₜ of 2-3 mW. From the PNG with an output power density of 0.1-0.2 mW/cm², assuming that occupies an area of 1 cm², the Pₒᵤₜ ranges from 0.1-0.2 mW. Considering that the NW based solar cell [21] occupies an area of 0.4 cm², assuming that the illumination intensity over this area is 17-100 mW/cm² and that the efficiency if 6%, the Pₒᵤₜ ranges from 0.41 mW-2.4 mW. From the above numbers, all these on-chip power supply devices can give a Pₒᵤₜ˜4 mW.

The recently introduced Phoenix processor is a very low power device that consumes just 39 pW. If this is assumed to be at the center of the on-chip control unit, using the plot in FIG. 6, the self-powered device is capable of running approximately 40000 transistors at the 45 nm node, 20000 transistors at the 32 nm node, 7000 transistors at the 22 nm node and a hypothetical 5000 transistors at the 16 nm technology node. FIG. 6 data on single transistor power dissipation at different technology nodes are based on theoretical calculations using the ASU predictive technology files at a 1 GHz clock frequency. The above approximations were made also taking into consideration the use of high-k/metal-gate. An even higher number of transistors may be powered using CNT and NW technology.

The CMOS inverter comprising a PMOS and NMOS is chosen as the test device because it is one of the simplest and most commonly used circuits. Power dissipation in such a circuit is mainly due to two components; dynamic power dissipation—switching and short-circuit power dissipation & static/leakage power dissipation—gate-leakage, sub-threshold and junction leakage.

Preliminary analysis was performed using predictive technology models (PTM) for NMOS and PMOS devices at 45 nm, 32 nm, 22 nm, & 16 nm technology nodes. The switching power dissipation was approximated by the capacitive load seen by the inverter output. The short circuit power was estimated by using an average model. For the purpose of analysis, all devices are assumed identical. Both NMOS and PMOS devices are assumed to have an aspect ratio of 8:1 and a 20% activity factor (β) operating at a 1 GHz clock frequency. The gate leakage power was estimated using the direct gate tunneling current equation. Supply voltages ranging from 0.9 V-1.2 V are used according to the PTM specified nominal voltages.

Power is dissipated as heat which is then reused (after conversion to electrical power) by a TEG. Two materials that may be used for a TEG are n-Bi₂Te₃ and p-(Bi,Sb)₂Te₃. The conversion efficiency and figure of merit (ZT) is much higher for this material. This material can be fabricated either by two wafer process or on a single Si substrate. The surface area for a processor is assumed to be about 1.43 cm². The number of transistors that can then be run using this regenerated power is estimated for different technology nodes with transistor count that follows Moore's law. The analysis is carried out by considering a die temperature of 85° C.

For a 45 nm CMOS transistor using a high K material such as La₂O₃ about 0.124 uW power is dissipated. At this technology node, the estimated total power dissipation for a 1.43 cm² processor is about 45.395 W. A transistor count of 700 million is assumed. Thermoelectric generation of this power produced an estimated 3.1 W using n-Bi₂Te₃/p-(Bi,Sb)₂Te₃ TEG. This is shown to be able to run about 9484 transistors in the processor. Power dissipation using this TEG at 16, 22 and 32 nm nodes is given in FIG. 6. As an adder is one of the most important elements in ALU of a microprocessor, we have simulated a mirror adder at 3 GHz clock using LTSpice at different technology nodes and determined average power requirement at node. Again, from FIG. 5, for a temperature difference of 62K (assuming microprocessor temperature of 85° C. and outside temperature of 23° C.), the output electrical power is 0.18 W/cm². So for a microprocessor of 1.43 cm² and 12 TEG modules, the total power is 3.1W. Using this electrical power, it is possible to operate 74,348 adders at 45 nm process node while 33,473 at 16 nm technology.

What is claimed is:

1. An integrated circuit comprising:
a substrate;
one or more power generation modules on the substrate;
one or more power storage modules on the substrate;
one or more control modules on the substrate, where the one or more control modules are configured to control the flow of energy between the one or more power generation modules and the one or more power storage modules; and
one or more communication modules on the substrate, where the one or more communication modules are configured to send and receive information to the one or more control modules.

2. The integrated circuit of claim 1, further comprising one or more sensors coupled to the one or more control modules, where the one or more control modules are responsive to an output of the sensor.

3. The integrated circuit of claim 2, where the one or more sensors consume less than about a microwatt of power.

4. The integrated circuit of claim 1, where the one or more power generation modules comprise a solar cell.

5. The integrated circuit of claim 4, where the solar cell comprises nanowires.

6. The integrated circuit of claim 1, where the one or more power generation modules comprise a piezoelectric energy harvester.

7. The integrated circuit of claim 1, where the one or more power generation modules comprise a thermoelectric energy harvester.

8. The integrated circuit of claim 1, where the one or more power generation modules comprise a fuel cell.

9. The integrated circuit of claim 8, where the one or more power generation modules comprise a microbial fuel cell.

10. The integrated circuit of claim 9, where the microbial fuel cell comprises a carbon nanotube having vertical walls.

11. The integrated circuit of claim 9, where the microbial fuel cell comprises a carbon nanotube having rounded walls.

12. The integrated circuit of claim 9, where the microbial fuel cell comprises a carbon nanotube having a slope greater than 50°.

13. The integrated circuit of claim 9, where the microbial fuel cell comprises a carbon nanotube having a slope greater than 70°.

14. The integrated circuit of claim 9, where the microbial fuel cell has a surface to volume ration greater than 500 cm⁻¹.

15. The integrated circuit of claim 1, where the one or more power storage modules comprise a battery.

16. The integrated circuit of claim 15, where the battery is a lithium ion battery.

17. The integrated circuit of claim 1, where the one or more control modules comprise a nano-electromechanical switch.
